(19) United States
(12) Patent Application Publication
(10) Pub. No.: US 2024/0276118 A1
(43) Pub. Date: Aug. 15, 2024

(54) IMAGING ELEMENT AND IMAGING DEVICE

(71) Applicant: NIKON CORPORATION, Tokyo (JP)

(72) Inventor: Daiki OGURA, Tokyo (JP)

(73) Assignee: NIKON CORPORATION, Tokyo (JP)

(21) Appl. No.: 18/563,660

(22) PCT Filed: May 25, 2022
(86) PCT No.: PCT/JP2022/021385

§ 371 Date: Nov. 22, 2023

(30) Foreign Application Priority Data
May 25, 2021 (JP) 2021-087850

(51) Int. Cl. H04N 25/766; H04N 25/779

(52) U.S. Cl. CPC H04N 25/766; H04N 25/779

(57) ABSTRACT

An imaging element includes: a plurality of first pixels which are respectively included in a plurality of regions, include first photoelectric conversion sections generating charges by photoelectrically converting light, output signals used to generate an image on the basis of the charges generated by the first photoelectric conversion sections, and are provided in a first direction and a second direction intersecting the first direction; a second pixel which includes a second photoelectric conversion section generating charges by photoelectrically converting light and outputs signals used to detect a focus on the basis of the charges generated by the second photoelectric conversion section; a first control line which controls the first pixels; and a second control line which controls the second pixel.

### TECHNICAL FIELD

The present invention relates to an imaging element and an imaging device.

Priority is claimed on Japanese Patent Application No. 2021-087850, filed May 25, 2021, the content of which is incorporated herein by reference.

### BACKGROUND ART

There is known an imaging element configured by laminating a pixel array substrate on which a plurality of pixels are arranged in array and a circuit substrate on which a plurality of signal processing sections supplying signals of driving the pixels to the pixels of the pixel array substrate are arranged in array (Patent Document 1). There has been a desire to improve the accuracy of focus detection.

### CITATION LIST

### Patent Document

### [Patent Document 1]

PCT International Publication No. WO 2017/18188

### SUMMARY OF INVENTION

An imaging element according to a first aspect of the present invention includes: a plurality of first pixels which are respectively included in a plurality of regions, include first photoelectric conversion sections generating charges by photoelectrically converting light, output signals used to generate an image on the basis of the charges generated by the first photoelectric conversion sections, and are provided in a first direction and a second direction intersecting the first direction; a second pixel which includes a second photoelectric conversion section generating charges by photoelectrically converting light and outputs signals used to detect a focus on the basis of the charges generated by the second photoelectric conversion section; a first control line which controls the first pixels; and a second control line which controls the second pixel.

An imaging element according to a second aspect of the present invention includes: a plurality of regions which include a plurality of first pixels including a first photoelectric conversion section generating charges by photoelectrically converting light, outputting a signal used to generate an image on the basis of the charges generated by the first photoelectric conversion section, and provided in a first direction and a second direction intersecting the first direction and a plurality of second pixels including second photoelectric conversion sections generating charges by photoelectrically converting light, outputting a signal used to detect a focus on the basis of the charges generated by the second photoelectric conversion sections, and arranged in the first direction; a first output unit which outputs a signal from the first pixel; and a second output unit which outputs a signal from the second pixel.

An imaging device according to a third aspect of the present invention includes: the imaging element according to the first or second aspect; and a generation unit which generates image data on the basis of a signal output from the imaging element.

### BRIEF DESCRIPTION OF DRAWINGS

FIG. 1 is a diagram showing a configuration example of an imaging device according to a first embodiment.

FIG. 2 is a diagram showing an example of a schematic configuration of a part of an imaging element according to the first embodiment.

FIG. 3 is a diagram showing a configuration example of a pixel of the imaging element according to the first embodiment.

FIG. 4 is a diagram showing a configuration example of a part of the imaging element according to the first embodiment.

FIG. 5 is a diagram showing an example of an operation of a pixel of the imaging element according to the first embodiment.

FIG. 6 is a diagram illustrating a configuration example of a pixel control unit of the imaging element according to the first embodiment.

FIG. 7 is a diagram showing an example of an operation of a pixel of the imaging element according to the first embodiment.

FIG. 8 is a diagram showing a configuration example of a part of an imaging element according to Modified Example 1.

FIG. 9 is a diagram showing a configuration example of a part of an imaging element according to Modified Example 2.

FIG. 10 is a diagram showing a configuration example of a part of the imaging element according to Modified Example 2.

FIG. 11 is a diagram showing another configuration example of a part of an imaging element according to Modified Example 3.

FIG. 12 is a diagram showing another configuration example of a part of the imaging element according to Modified Example 3.

FIG. 13 is a diagram showing another configuration example of a part of the imaging element according to Modified Example 3.

FIG. 14 is a diagram showing another configuration example of a part of the imaging element according to Modified Example 3.

FIG. 15 is a diagram showing another configuration example of a part of the imaging element according to Modified Example 3.

FIG. 16 is a diagram showing a configuration example of a pixel of an imaging element according to Modified Example 4.

### DESCRIPTION OF EMBODIMENTS

### First Embodiment

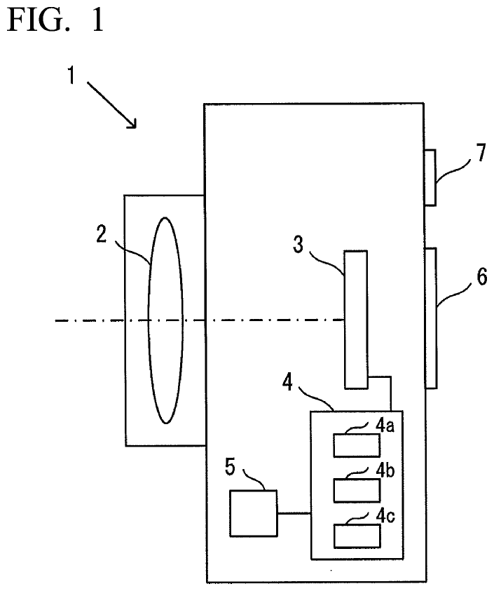

FIG. 1 is a diagram showing a configuration example of a camera 1 which is an example of an imaging device according to a first embodiment. The camera 1 includes a photographic optical system (imaging optical system) 2, an imaging element 3, a control unit 4, a memory 5, a display unit 6, and an operation unit 7. The photographic optical system 2 includes a plurality of lenses including a focusing lens and an aperture diaphragm and forms a subject image on the imaging element 3. Additionally, the photographic optical system 2 may be attachable to and detachable from the camera 1.

The imaging element 3 is an imaging element such as a CMOS image sensor or a CCD image sensor. The imaging element 3 receives a light flux having passed through the photographic optical system 2 and captures the subject image formed by the photographic optical system 2. A plurality of pixels each having a photoelectric conversion section are arranged two-dimensionally (in the row direction and the column direction) in the imaging element 3. The photoelectric conversion section is composed of a photodiode (PD). The imaging element 3 photoelectrically converts the received light to generate a signal and outputs the generated signal to the control unit 4.

The imaging element 3 includes an imaging pixel and an AF pixel (focus detection pixel). The imaging pixel outputs a signal used to generate an image. The AF pixel outputs a signal used to detect a focus. The AF pixels are arranged to replace a part of the imaging pixels and are distributed over almost the entire imaging surface of the imaging element 3. Additionally, in the following description, when the pixel is simply referred, any one or both the imaging pixel and the AF pixel are referred.

The memory 5 is a recording medium such as a memory card. Image data, programs, and the like are recorded in the memory 5. Writing data to the memory 5 and reading data from the memory 5 are controlled by the control unit 4. The display unit 6 displays images based on image data, information regarding photography such as shutter speed and aperture value, and a menu screen. The operation unit 7 includes various setting switches such as a release button, a power switch, and switches for switching various modes and outputs signals based on the respective operations to the control unit 4.

The control unit 4 includes devices such as CPU, GPU, FPGA, and ASIC and memories such as ROM and RAM. The control unit 4 reads and executes a program stored in the memory to control each part of the camera 1. The control unit 4 includes an imaging control section 4a, an image data generation section 4b, and a focus detection section 4c.

The imaging control section 4a supplies a signal of controlling the imaging element 3 to the imaging element 3 and controls the operation of the imaging element 3. The imaging control section 4a allows the imaging element 3 to capture a subject image and outputs a signal when photographing a still image, when photographing a video, when displaying a through image (live view image) of a subject on the display unit 6, and the like.

The image data generation section 4b performs various types of image processing on signals output from the imaging pixels of the imaging element 3 to generate image data (still image data, video data). The image processing includes image processing such as gradation conversion processing and color interpolation processing. Additionally, the image data generation section 4b may also generate image data using signals output from the AF pixels.

The focus detection section 4c performs focus detection processing necessary for automatic focus adjustment (AF) of the photographic optical system 2. The focus detection section 4c detects the focus position of the focus lens (the movement amount of the focus lens to the focus position) for focusing (forming an image) an image produced by the photographic optical system 2 on the imaging surface of the imaging element 3. The focus detection section 4c calculates a defocus amount by a phase difference detection method using first and second signals output from a pair of AF pixels (AF pixel pair) of the imaging element 3.

The focus detection section 4c calculates an image shift amount by calculating a correlation between a first signal generated by capturing an image of a first light flux having passed through a first region of an exit pupil of the photographic optical system 2 and a second signal generated by capturing an image of a second light flux having passed through a second region thereof. The focus detection section 4c converts this image shift amount into a defocus amount on the basis of a predetermined conversion formula. The focus detection section 4c calculates the movement amount of the focus lens to the focus position on the basis of the calculated defocus amount. Since the focus lens is driven according to the movement amount, the focus is automatically adjusted. In this way, the control unit 4 controls the position of the focus lens so that the image of the subject formed by the photographic optical system 2 is focused on the imaging element 3.

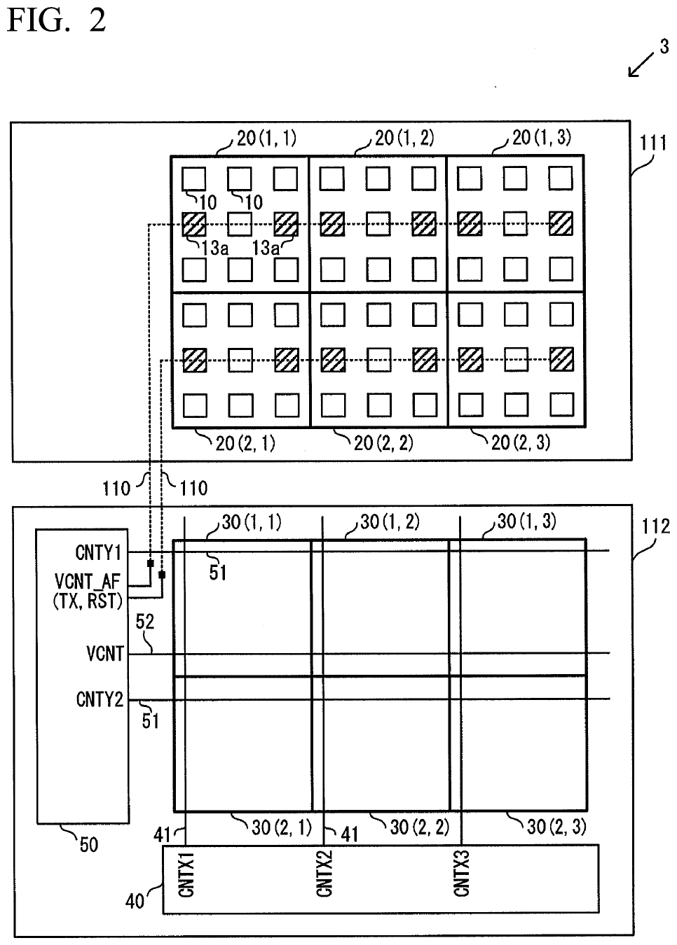

FIG. 2 is a diagram showing an example of a schematic configuration of a part of the imaging element according to the first embodiment. The imaging element 3 is configured by laminating a first substrate 111 provided with a plurality of pixels and a second substrate 112 provided with a control unit to be described later. Each of the first substrate 111 and the second substrate 112 is configured by using a semiconductor substrate. A circuit provided on the first substrate 111 and a circuit provided on the second substrate 112 are electrically connected via a connection portion such as an electrode and a bump.

The first substrate 111 includes a plurality of imaging pixels 10 and an AF pixel 13 (13a, 13b) which are arranged two-dimensionally. Each of the first AF pixel 13a and the second AF pixel 13b includes a light shielding portion which blocks a part of light that enters the photoelectric conversion section. The first AF pixel 13a and the second AF pixel 13b have different positions of the light shielding portions.

The light shielding portions of the first AF pixel 13a and the second AF pixel 13b are arranged so that light having passed through different regions of the exit pupil of the photographic optical system 2 enters the photoelectric conversion section. Accordingly, the photoelectric conversion section of the first AF pixel 13a receives the light flux having passed through the first region in the first and second regions of the exit pupil of the photographic optical system 2. The photoelectric conversion section of the second AF pixel 13b receives the light flux having passed through the second region in the first and second regions of the exit pupil of the photographic optical system 2.

The first substrate 111 has a plurality of regions 20 in which the imaging pixel 10, the first AF pixel 13a, and the second AF pixel 13b are respectively arranged. In the example shown in FIG. 2, six regions 20 are shown. Each of these six regions 20 indicates one region when the region where pixels of the first substrate 111 are arranged is divided into regions including a predetermined number of pixels. Additionally, the regions 20 may partially overlap each other or may not overlap each other. The number of pixels in each region 20 may be 9 pixels (3 pixels×3 pixels), 16 pixels (4 pixels×4 pixels), or any number. In the following description, the region 20 is referred to as a pixel block 20.

In each of the plurality of pixel blocks 20 of the imaging element 3, a plurality of imaging pixels 10 are arranged in the row direction (horizontal direction) which is a first direction and the column direction (vertical direction) which is a second direction intersecting the first direction. Additionally, in the drawing, the shaded pixel is the AF pixel 13. In the example shown in FIG. 2, seven imaging pixels 10, one first AF pixel 13a, and one second AF pixel 13b are provided in the pixel block 20. The first AF pixel 13a and the second AF pixel 13b are arranged side by side in the row direction. In the first substrate 111, a plurality of pixel blocks 20 are provided in the row direction and the column direction.

The second substrate 112 includes a control unit 30 (hereinafter, referred to as a pixel control unit), a control unit 40 (hereinafter, referred to as a vertical control unit), and a control unit 50 (hereinafter, referred to as a horizontal control unit). The pixel control unit 30 is provided for each pixel block 20. In FIG. 2, six pixel control units 30 are shown. In the second substrate 112, a plurality of pixel control units 30 are provided in the row direction and the column direction.

The pixel control unit 30 (1, 1) is provided for the pixel block 20 (1, 1). The pixel control unit 30 (1, 2) is provided for the pixel block 20 (1, 2) and the pixel control unit 30 (1, 3) is provided for the pixel block 20 (1, 3). Further, the pixel control units 30 (2, 1), 30 (2, 2), and 30 (2, 3) are respectively provided for the pixel blocks 20 (2, 1), 20 (2, 2), and 20 (2, 3).

As shown in FIG. 2, the vertical control unit 40 and the horizontal control unit 50 are provided around a region in which each pixel control unit 30 is disposed in the second substrate 112. It can also be said that the vertical control unit 40 and the horizontal control unit 50 are provided for the plurality of pixel blocks 20. Further, as shown in FIG. 2, a signal line 41, a signal line 51, a signal line 52, and a signal line 110 are provided on the second substrate 112.

The signal line 41 is provided for each of the plurality of pixel control units 30 arranged in the longitudinal direction, that is, the vertical direction (column direction). The signal line 41 is connected to each of the pixel control units 30 arranged in the vertical direction and the vertical control unit 40. The signal line 41 is a signal line (hereinafter, referred to as a vertical control line) to which a signal CNTX of controlling the pixel control unit 30 is transmitted. In FIG. 2, a vertical control line 41 to which a signal CNTX1 is transmitted, a vertical control line 41 to which a signal CNTX2 is transmitted, and a vertical control line 41 to which a signal CNTX3 is transmitted are shown.

Each of the vertical control lines 41 can be configured by a plurality of signal lines corresponding to the number of signals CNTX to be transmitted. In the example shown in FIG. 2, the vertical control line 41 which transmits the signal CNTX1 can be configured by a plurality of signal lines corresponding to the number of bits of the signal CNTX1. Further, two vertical control lines 41 which respectively transmit the signal CNTX2 and the signal CNTX3 can be respectively configured by a plurality of signal lines corresponding to the number of bits of the signal CNTX2 and the signal CNTX3. The vertical control unit 40 controls the operation of the pixel control unit 30 by supplying the signal CNTX to the vertical control line 41.

The signal line 51 is provided for each of the plurality of pixel control units 30 arranged in the lateral direction, that is, the horizontal direction (row direction). The signal line 51 is connected to each of the pixel control units 30 arranged in the horizontal direction and the horizontal control unit 50. The signal line 51 is a signal line (hereinafter, referred to as a horizontal control line) to which a signal CNTY controlling the pixel control unit 30 is transmitted. In FIG. 2, a horizontal control line 51 to which a signal CNTY1 is transmitted and a horizontal control line 51 to which a signal CNTY2 is transmitted are shown.

Each of the horizontal control lines 51 can be configured by a plurality of signal lines corresponding to the number of signals CNTY to be transmitted. In the example shown in FIG. 2, the horizontal control line 51 which transmits the signal CNTY1 can be configured by a plurality of signal lines corresponding to the number of bits of the signal CNTY1. Further, the horizontal control line 51 which transmits the signal CNTY2 can be configured by a plurality of signal lines corresponding to the number of bits of the signal CNTY2. The horizontal control unit 50 controls the operation of the pixel control unit 30 by supplying the signal CNTY to the horizontal control line 51.

The signal line 52 is connected to the horizontal control unit 50 and the plurality of pixel control units 30. The signal line 52 is commonly connected to the plurality of pixel control units 30 provided on the second substrate 112. The signal line 52 is a signal line (hereinafter, referred to as a pixel drive line) to which a signal VCNT used to control the pixels is transmitted and the signal VCNT is supplied from the horizontal control unit 50. The pixel drive line 52 is configured by a plurality of signal lines corresponding to the number of bits of the signal VCNT to be transmitted. Additionally, the pixel drive line 52 may be commonly provided in all pixel control units 30 or may be provided for each of the plurality of pixel control units 30 arranged in the horizontal direction.

The pixel control unit 30 is controlled by the vertical control unit 40 and the horizontal control unit 50, supplies a signal of controlling the imaging pixel 10 to each imaging pixel 10 of the pixel block 20, and controls the operation of each imaging pixel 10. The pixel control unit 30 according to this embodiment constitutes a part of an output unit which outputs a signal of controlling a charge accumulation time of a photoelectric conversion section 11 of the imaging pixel 10. The pixel control unit 30 supplies a signal to a gate of each transistor of the imaging pixel 10 so that the transistor is in an on state (connected state, conductive state, short circuit state) or an off state (disconnected state, non-conductive state, open state, cutoff state).

The pixel control unit 30 outputs a signal such as a signal TX and a signal RST to be described later to each imaging pixel 10 in the pixel block 20 on the basis of the signal CNTX, the signal CNTY, and the signal VCNT. The pixel control unit 30, the vertical control unit 40, and the horizontal control unit 50 control a charge accumulation time in each imaging pixel 10 of the pixel block 20 by controlling the signal TX, the signal RST, and the like input to the imaging pixel 10 of the pixel block 20. Additionally, a part or all of the pixel control unit (the output unit) 30 may be disposed on the first substrate 111.

The signal line 110 is provided for each of the plurality of AF pixels 13 arranged in the horizontal direction (row direction). In the example shown in FIG. 2, the signal line 110 commonly connected to the plurality of first AF pixels 13a and second AF pixels 13b of the pixel blocks 20 (1, 1) to (1, 3) and the signal line 110 commonly connected to the plurality of first AF pixels 13a and second AF pixels 13b of the pixel blocks 20 (2, 1) to (2, 3) are shown. The signal line 110 is connected to the horizontal control unit 50 and the plurality of AF pixels 13 of each pixel block 20. The signal line 110 is a signal line (control line) to which a signal controlling the AF pixel 13 is transmitted. The signal line 110 includes a signal line to which the signal TX used to control the AF pixel 13 is transmitted and the signal TX is supplied from the horizontal control unit 50. Further, the signal line 110 includes a signal line to which the signal RST used to control the AF pixel 13 is transmitted and the signal RST is supplied from the horizontal control unit 50.

The horizontal control unit 50 controls the operation of each AF pixel 13 by supplying a signal of controlling the AF pixel 13 to each AF pixel 13 of the pixel block 20 via the signal line 110. The horizontal control unit 50 of this embodiment constitutes a part of an output unit which outputs a signal of controlling a charge accumulation time of the photoelectric conversion section 11 of the AF pixel 13. The horizontal control unit 50 supplies a signal to a gate of each transistor of the AF pixel 13 so that the transistor is in an on state or an off state.

The horizontal control unit 50 outputs a signal such as the signal TX and the signal RST to each AF pixel 13 in the pixel block 20 via the signal line 110. The horizontal control unit 50 controls a charge accumulation period in each AF pixel 13 of the pixel block 20 by controlling the signal TX, the signal RST, and the like input to the AF pixel 13 of the pixel block 20. Additionally, a part or all of the horizontal control unit (output unit) 50 may be disposed on the first substrate 111.

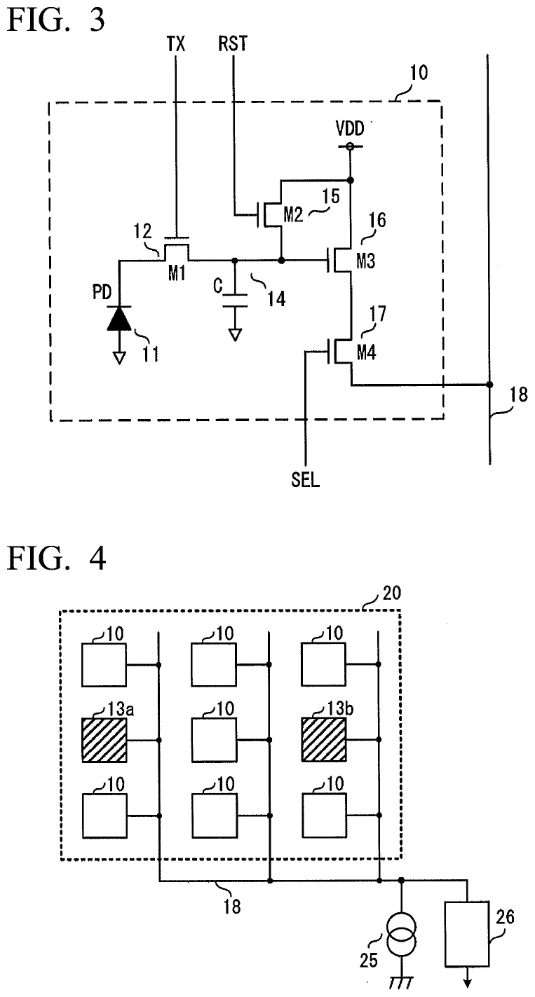

FIG. 3 is a diagram showing a configuration example of the pixel of the imaging element according to the first embodiment. The pixel 10 includes the photoelectric conversion section 11, a transmission section 12, a floating diffusion (FD) 14, a discharge section 15, an amplification section 16, and a selection section 17. Additionally, in this embodiment, the circuit configuration of the AF pixel 13 is the same as the circuit configuration of the imaging pixel 10. The photoelectric conversion section 11 is a photodiode PD, converts incident light into charges, and accumulates the photoelectrically converted charges.

The transmission section 12 is composed of a transistor M1 controlled by the signal TX and electrically connects or disconnects the photoelectric conversion section 11 and an FD 14. The transmission section 12 transmits charges photoelectrically converted by the photoelectric conversion section 11 to the FD 14. The transistor M1 is a transmission transistor. A capacitor C of the FD 14 accumulates (holds) the charge transmitted to the FD 14 and converts the charge into a voltage divided by a capacitance value. The FD 14 is an accumulation section 14 and accumulates charges generated by the photoelectric conversion section 11.

The amplification section 16 is composed of a transistor M3 of which a gate (terminal) is connected to the FD 14 and amplifies and outputs a signal due to charges accumulated in the capacitor C of the FD 14. A drain (terminal) and a source (terminal) of the transistor M3 are respectively connected to a power supply line (power supply voltage VDD) and the selection section 17. A source of the amplification section 16 is connected to a signal line 18 via the selection section 17. The transistor M3 is an amplification transistor. The amplification section 16 and the selection section 17 constitute an output unit which generates a signal based on charges generated by the photoelectric conversion section 11 and outputs the signal.

The discharge section 15 is composed of a transistor M2 controlled by the signal RST and resets the charge accumulated by the FD 14. The discharge section (reset section) 14 discharges the charge accumulated in the FD 14 and resets the voltage of the FD 14. The transistor M2 is a reset transistor.

The selection section 17 is composed of a transistor M4 controlled by a signal SEL and electrically connects or disconnects the amplification section 16 and the signal line 18. The transistor M4 of the selection section 17 outputs a signal from the amplification section 16 to the signal line 18 when in an on state. The transistor M4 is a selection transistor.

FIG. 4 is a diagram showing a configuration example of a part of the imaging element according to the first embodiment. In FIG. 4, one pixel block 20 of the plurality of pixel blocks 20 provided in the imaging element 3, one current source 25, and one processing section 26 are shown.

The current source 25 is connected to each of the pixels (the imaging pixel 10, the AF pixel 13) via the signal line 18. The current source 25 generates a current for reading a signal from the pixel and supplies the generated current to the signal line 18 and the amplification section 16 and the selection section 17 of each pixel. The current source 25 is disposed for each pixel block 20.

The processing section 26 includes an analog/digital conversion section (AD conversion section). The processing section 26 converts a pixel signal which is an analog signal input from each pixel via the signal line 18 into a digital signal. Additionally, the processing section 26 may include an amplifier which amplifies the pixel signal input via the signal line 18 with a predetermined gain (amplification factor). In this case, the processing section 26 may convert the pixel signal amplified by the amnplifier into a digital signal.

The pixel signal converted into the digital signal is subjected to signal processing such as correlated double sampling and signal amount correction processing in the processing section 26 and then output to the control unit 4 of the camera 1. Additionally, signal processing such as correlated double sampling on pixel signals may be performed in a signal processing section (not shown). In this case, the processing section 26 outputs the pixel signal converted into the digital signal to the signal processing section. The signal processing section performs signal processing such as correlated double sampling on the input pixel signal and then outputs the processed signal to the control unit 4.

Additionally, the current source 25 and the processing section 26 may be arranged on the first substrate 111 or the second substrate 112. Further, the processing section 26 may be separately disposed on the first substrate 111 and the second substrate 112 or may be disposed on a substrate different from the first substrate 111 and the second substrate 112.

In this embodiment, the pixel control unit 30 outputs the signal TX and the signal RST which are used to control the charge accumulation in the imaging pixel 10 and the horizontal control unit 50 different from the pixel control unit 30 outputs the signal TX and the signal RST which are used to control the charge accumulation in the AF pixel 13. Therefore, the time (charge accumulation time) for accumulating charges in the imaging pixel 10 and the AF pixel 13 in the pixel block 20 can be independently (separately) controlled. The pixel control unit 30 controls the charge accumulation time of the imaging pixel 10 of the pixel block 20 and the horizontal control unit 50 controls the charge accumulation time of the AF pixel 13 of the pixel block 20. Hereinafter, the imaging element 3 according to this embodiment will be further described.

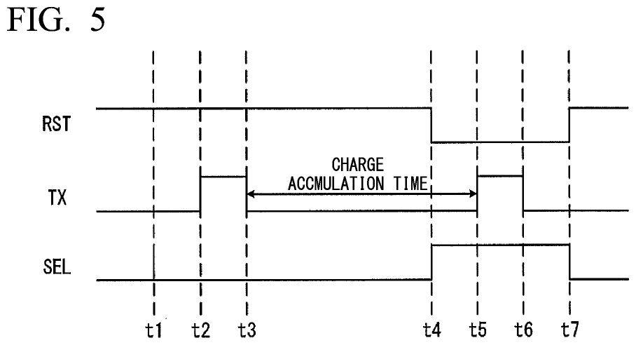

FIG. 5 is a diagram showing an example of an operation of the pixel of the imaging element according to the first embodiment. In the timing chart shown in FIG. 5, the horizontal axis indicates the time and indicates the control signal input to the pixel of the imaging element 3. In FIG. 5, the transistor to which a high level (for example, power supply voltage VDD) control signal (the signal RST, the signal TX, the signal SEL) is input is in an on state and the transistor to which a low level (for example, ground voltage) control signal is input is in an off state.

Since the signal RST is at a high level at the time t1 shown in FIG. 5, the transistor M2 of the discharge section 15 is in an on state. Since the signal TX is at the high level at the time t2, the transistor M1 of the transmission section 12 is in an on state. Since both the signal RST and the signal TX are at a high level, the power supply line (power supply voltage VDD), the FD 14, and the photoelectric conversion section 11 are electrically connected. Accordingly, the charge of the photoelectric conversion section 11 is discharged and the voltage of the photoelectric conversion section 11 is reset.

Since the signal TX is at a low level at the time t3, the transistor M1 of the transmission section 12 is in an off state and the photoelectric conversion section 11 and the FD 14 are electrically disconnected. The photoelectric conversion section 11 photoelectrically converts the light from the subject and accumulates the generated charge. Since the signal RST is at a high level, the charge of the FD 14 is discharged and the voltage of the FD 14 is reset.

Since the signal RST is at a low level at the time t4, the transistor M2 of the discharge section 15 is in an off state. Further, since the signal SEL is at a high level at the time t4, the transistor M4 of the selection section 17 is in an on state. Accordingly, the signal based on the reset voltage, that is, the signal after resetting the charge of the FD 14 is output to the signal line 18 by the amplification section 16 and the selection section 17. The signal based on the reset voltage is input to the processing section 26 via the signal line 18 as a dark signal. The dark signal is an analog signal based on the reset voltage and is converted into a digital signal by the processing section 26.

At the time t5, the signal TX is at a high level. Since the signal TX is at a high level, the transistor M1 of the transmission section 12 is in an on state and the photoelectric conversion section 11 and the FD 14 are electrically connected. Accordingly, charges photoelectrically converted by the photoelectric conversion section 11 are transmitted to the FD 14. Further, since the signal SEL is at a high level, the signal according to the charges transmitted to the FD 14, that is, the signal (pixel signal) based on the charges generated by the photoelectric conversion section 11 is output to the signal line 18 by the amplification section 16 and the selection section 17. The pixel signal is input to the processing section 26 via the signal line 18. The pixel signal is an analog signal generated on the basis of charges photoelectrically converted by the photoelectric conversion section 11 and is converted into a digital signal by AD conversion from the time t6 using the processing section 26.

Further, at the time t6, the signal TX is at a low level and the transistor M1 of the transmission section 12 is in an off state. At the time t7, the signal SEL is at a low level and the transistor M4 of the selection section 17 is in an off state. Further, at the time t7, the signal RST is at a high level and the transistor M2 of the discharge section 15 is in an on state.

The processing section 26 performs signal processing such as correlated double sampling using the dark signal converted into a digital signal and the pixel signal. The pixel signal of the imaging pixel 10 is subjected to signal processing such as correlated double sampling by the processing section 26 and then output to the control unit 4 of the camera 1. Additionally, the pixel signal of the first AF pixel 13a and the pixel signal of the second AF pixel 13b are subjected to signal processing by the processing section 26 and then output to the control unit 4 as a pair of signals (first and second signals).

The period from the time t3 to the time t5 shown in FIG. 5 is the above-described charge accumulation time and is a period in which the charge accumulation operation is performed. Each pixel of the imaging element 3 photoelectrically converts the light having passed through the photographic optical system 2 and accumulates charges. The pixel (the imaging pixel 10, the AF pixel 13) generates a pixel signal on the basis of a charge amount accumulated for the charge accumulation time and outputs the pixel signal to the signal line 18.

The pixel control unit 30 according to this embodiment controls the charge accumulation time of the imaging pixel 10 by supplying the signal TX and the signal RST to the imaging pixel 10 of the pixel block 20. Further, the horizontal control unit 50 controls the charge accumulation time of the AF pixel 13 by supplying the signal TX and the signal RST to the AF pixel 13 of the pixel block 20.

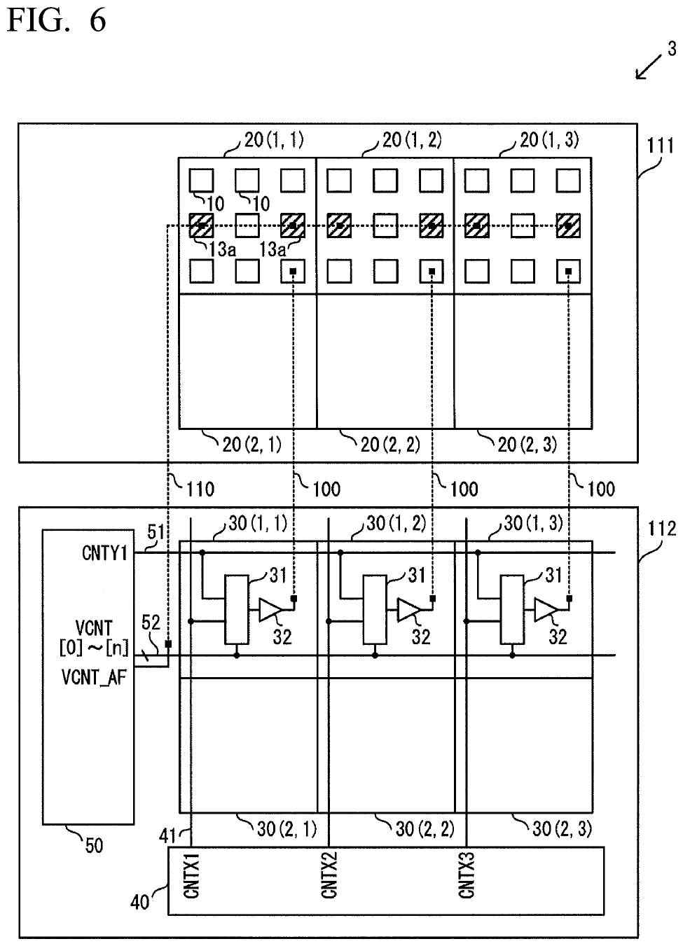

FIG. 6 is a diagram illustrating a configuration example of the pixel control unit of the imaging element according to the first embodiment. The pixel control unit 30 includes a selection circuit section 31 and a buffer 32. The selection circuit section 31 is composed of a multiplexer controlled by the vertical control unit 40 and the horizontal control unit 50. The signal CNTX is input from the vertical control unit 40 to the selection circuit section 31 via the vertical control line 41 and the signal CNTY is input from the horizontal control unit 50 thereto via the horizontal control line 51.

Further, a plurality of different types of signals VCNT are input from the horizontal control unit 50 to the selection circuit section 31 by the pixel drive line 52 composed of a plurality of signal lines. For example, these types of signals VCNT have different timings at which they reach a high level or a low level. The selection circuit section 31 selects a signal output to the imaging pixel 10 of the pixel block 20 via the buffer 32 from a plurality of types of input signals VCNT on the basis of the signal CNTX and the signal CNTY. The selection circuit section 31 outputs, for example, the signal VCNT selected according to a combination of signal levels of the signal CNTX and the signal CNTY to the buffer 32 as the signal TX.

The buffer 32 buffers (amplifies) the signal TX output from the selection circuit section 31 and supplies the signal TX to each imaging pixel 10 of the pixel block 20 via a signal line 100. The signal line 100 is provided for each pixel control unit 30, that is, each pixel block 20. The signal line 100 is a signal line which connects the pixel control unit 30 of the second substrate 112 and the pixel block 20 of the first substrate 111 and is formed using electrodes, bumps, and the like.

The signal line 100 is commonly connected to the plurality of imaging pixels 10 of the pixel block 20. The signal line 100 is composed of a plurality of signal lines corresponding to the signal output from the pixel control unit 30 to the pixel block 20. The signal line 100 includes a signal line (control line) to which the signal TX used to control the imaging pixel 10 is transmitted and the signal TX is supplied from the buffer 32. In the imaging pixel 10, the signal TX of controlling the transmission section 12 is input to the gate of the transistor M1 of the transmission section 12 via the signal line 100.

The vertical control unit 40 and the horizontal control unit 50 can individually (independently) control the signal TX supplied to the imaging pixel 10 of each pixel block 20 by controlling the signal CNTY and the signal CNTX input to the selection circuit section 31 of each pixel control unit 30.

Further, although not shown in FIG. 6, the pixel control unit 30 includes a selection circuit section which outputs the signal RST of controlling the discharge section 15 of the imaging pixel 10 of the pixel block 20, a buffer, and the like. The signal line 100 includes a signal line to which the signal RST used to control the imaging pixel 10 is transmitted and the signal RST is supplied from the buffer of the pixel control unit 30. In the imaging pixel 10, the signal RST of controlling the discharge section 15 is input to the gate of the transistor M2 of the discharge section 15 via the signal line 100. The vertical control unit 40 and the horizontal control unit 50 can individually control the signal RST supplied to the imaging pixel 10 of each pixel block 20 by controlling each pixel control unit 30.

Additionally, the pixel control unit 30 may include a logic circuit (AND circuit, OR circuit, and the like), a latch circuit, a buffer, and the like. In this case, the pixel control unit 30 may generate the signal TX, the signal RST, and the like on the basis of the resister setting value input from the vertical control unit 40 and the horizontal control unit 50 and output the signal TX, the signal RST, and the like to the imaging pixel 10. The vertical control unit 40 and the horizontal control unit 50 can individually control the signal TX supplied to each pixel block 20 by outputting the register setting value to each pixel control unit 30. Further, the vertical control unit 40 and the horizontal control unit 50 can individually control the signal RST supplied from the pixel control unit 30 to each pixel block 20.

The horizontal control unit 50 includes a logic circuit, a latch circuit, a buffer, and the like, generates the signal TX of controlling the transmission section 12 of the AF pixel 13 of the pixel block 20, and supplies the signal TX to each AF pixel 13 of the pixel block 20 via the signal line 110. As described above, the signal line 110 is a signal line which connects the horizontal control unit 50 of the second substrate 112 and the pixel block 20 of the first substrate 111 and is formed using electrodes, bumps, and the like. In the AF pixel 13, the signal TX of controlling the transmission section 12 is input to the gate of the transistor M1 of the transmission section 12 via the signal line 110.

Further, the horizontal control unit 50 generates the signal RST of controlling the discharge section 15 of the AF pixel 13 of the pixel block 20 and supplies the signal RST to each AF pixel 13 of the pixel block 20 via the signal line 110. In the AF pixel 13, the signal RST of controlling the discharge section 15 is input to the gate of the transistor M2 of the discharge section 15 via the signal line 110.

In this way, the signal TX and the signal RST are supplied from the pixel control unit 30 to the imaging pixel 10 of the pixel block 20 via the signal line 100. Further, the signal TX and the signal RST are supplied from the horizontal control unit 50 to the AF pixel 13 of the pixel block 20 via the signal line 110. Therefore, the pixel control unit 30 and the horizontal control unit 50 can set the charge accumulation time (exposure time) of each of the imaging pixel 10 and the AF pixel 13 by separately controlling the timings of turning on and off the transistor M1 of the transmission section 12 and the transistor M2 of the discharge section 15 in the imaging pixel 10 and the AF pixel 13.

Further, the pixel control unit 30 and the horizontal control unit 50 can separately control the timing of tuning on and off the transistor M2 of the discharge section 15 in the imaging pixel 10 and the AF pixel 13. The pixel control unit 30 and the horizontal control unit 50 may adjust the charge accumulation start time by controlling the charge discharge timing of the photoelectric conversion section 11 using the discharge section 15.

The pixel control unit 30 and the horizontal control unit 50 can control the charge accumulation time to be different in the imaging pixel 10 and the AF pixel 13 or control the charge accumulation time to be the same in the imaging pixel 10 and the AF pixel 13.

The pixel control unit 30 is also provided with a buffer, a control circuit, and the like which output the above-described signal SEL. The pixel control unit 30 performs control of sequentially selecting each pixel in the pixel block 20 and reading a signal from the selected pixel. The control circuit of the pixel control unit 30 supplies the signal SEL to each pixel of the pixel block 20 via the buffer and sequentially outputs each pixel signal to the above-described signal line 18. The imaging pixel 10 and the AF pixel 13 of the pixel block 20 are sequentially selected by the pixel control unit 30. Additionally, the buffer, the control circuit, and the like outputting the signal SEL may be provided in the horizontal control unit 50 and the horizontal control unit 50 may perform control of sequentially reading a signal from each pixel in the pixel block 20.

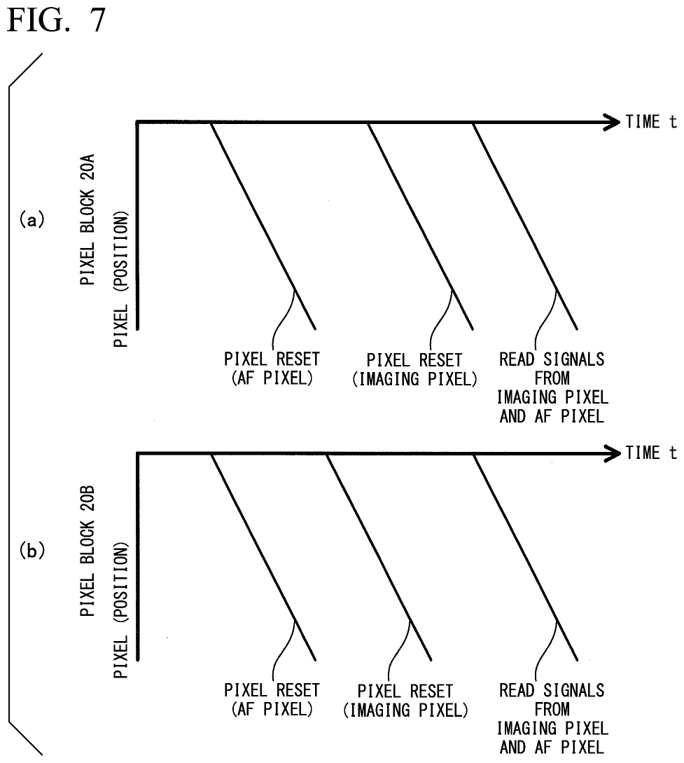

FIG. 7 is a diagram showing an example of an operation of the pixel of the imaging element according to the first embodiment. The vertical axis indicates (the position of) the pixel in the pixel block 20 and the horizontal axis indicates the timing (time t) of performing the resetting operation and the reading operation of each pixel. FIG. 7 schematically shows the transition of the pixel when performing the operation (resetting operation) of discharging the charges accumulated in the pixel and the operation (reading operation) of reading the signal based on the charges accumulated in the pixel from the pixel.

In the example shown in FIG. 7, the resetting operation and the reading operation are performed while scanning the pixel of the pixel block 20. FIG. 7(a) shows an operation example of the pixel of a certain pixel block 20A (for example, the pixel block 20 (1, 1)) and FIG. 7(b) shows an operation example of the pixel of another pixel block 20B (for example, the pixel block 20 (1, 2)).

As shown in FIG. 7(a) and FIG. 7(b), the horizontal control unit 50 performs the resetting operation of the AF pixel 13 of the pixel block 20 (1, 1) and the resetting operation of the AF pixel 13 of the pixel block 20 (1, 2) simultaneously (in parallel). The pixel control unit 30 (1, 1) performs the resetting operation of the imaging pixel of the pixel block 20 (1, 1) and the reading operation of the imaging pixel 10 and the AF pixel 13 of the pixel block 20 (1, 1) as shown in FIG. 7(a). The pixel control unit 30 (1, 2) performs the resetting operation of the imaging pixel of the pixel block 20 (1, 2) and the reading operation of the imaging pixel 10 and the AF pixel 13 of the pixel block 20 (1, 2) as shown in FIG. 7(b). The pixel control unit 30 and the horizontal control unit 50 can set different charge accumulation times in the imaging pixel 10 and the AF pixel 13 by performing the resetting operation at different timings in the imaging pixel 10 and the AF pixel 13 as shown in FIG. 7.

The imaging element 3 may control the charge accumulation time of the AF pixel 13 depending on the brightness of the subject. The imaging element 3 shortens the charge accumulation time of the AF pixel 13 when the subject is bright, so that the first and second signals of the AF pixel pair (the first AF pixel 13a, the second AF pixel 13b) can be read at a high speed and the time required for focus adjustment can be shortened. Further, the imaging element 3 lengthens the charge accumulation time of the AF pixel 13 when the subject is dark, so that a decrease in the accuracy of focus detection using the first and second signals can be suppressed.

Further, in this embodiment, as shown in FIGS. 2 and 6, all AF pixels 13 located at the same row in the plurality of AF pixels of each pixel block 20 are commonly connected to the same signal line 110 and the charge accumulation time is controlled by the signal TX and the like supplied from the signal line 110. Therefore, it is possible to suppress a decrease in the correlation between the first signal and the second signal and to prevent a decrease in the accuracy of focus detection using the first and second signals.

According to the above-described embodiments, the following operation and effect can be obtained.

(1) The imaging element 3 includes: a plurality of first pixels (imaging pixels 10) which are respectively included in a plurality of regions (pixel blocks 20), include first photoelectric conversion sections which generate charges by photoelectrically converting light, output signals used to generate an image on the basis the charges generated by the first photoelectric conversion sections, and are provided in a first direction and a second direction intersecting the first direction; a second pixel (AF pixel 13) which includes a second photoelectric conversion section generating charges by photoelectrically converting light and outputs signals used to detect a focus on the basis of the charges generated by the second photoelectric conversion section; a first output unit which outputs a signal of controlling the first pixels; and a second output unit which outputs a signal of controlling the second pixel. In this embodiment, the pixel control unit 30 outputs a signal of controlling the imaging pixel 10 and the horizontal control unit 50 outputs a signal of controlling the AF pixel 13. Therefore, it is possible to independently control the imaging pixel 10 and the AF pixel 13 in the pixel block 20.

(2) In this embodiment, the charge accumulation time of the imaging pixel 10 of the pixel block 20 is controlled by the pixel control unit 30 and the charge accumulation time of the AF pixel 13 of the pixel block 20 is controlled by the horizontal control unit 50. Therefore, the imaging element 3 can separately set the charge accumulation time for the imaging pixel 10 and the AF pixel 13 in the pixel block 20.

The following modifications are also within the scope of the present invention and one or more of modified examples can be combined with the above-described embodiment.

### Modified Example 1

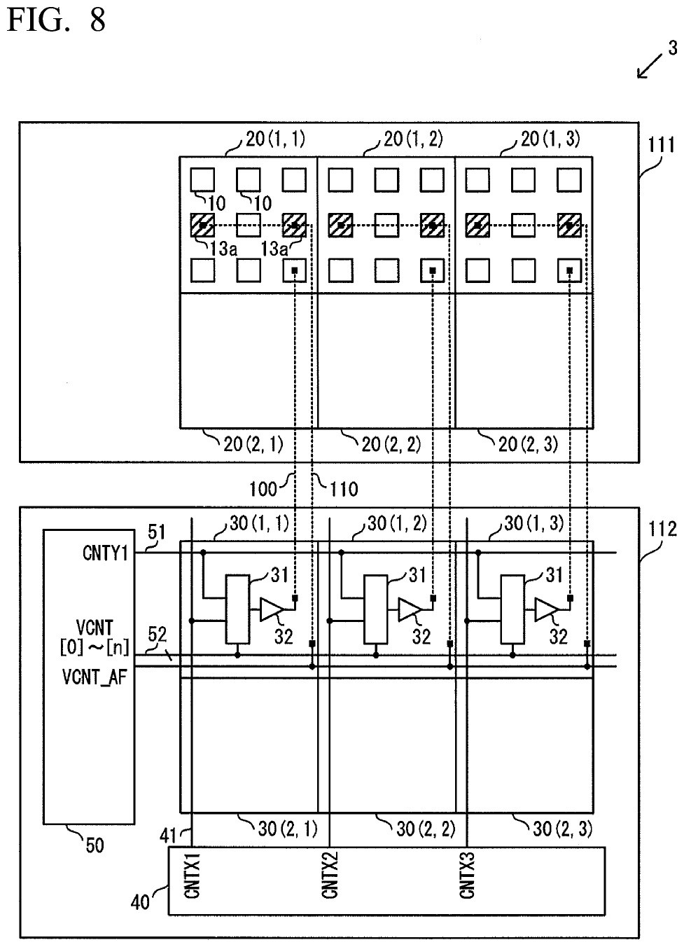

In the above-described embodiment, an example in which the signal line 110 is provided to extend from the horizontal control unit 50 to the first substrate 111 has been described with reference to FIGS. 2 and 6. As shown in FIG. 8, the signal line 110 may be provided to extend from the horizontal control unit 50 to the position of the pixel control unit 30 and extend from the position of the pixel control unit 30 to the first substrate 111.

### Modified Example 2

In the above-described embodiment, an example in which the horizontal control unit 50 outputs the signal TX, the signal RST, and the like of controlling the AF pixel 13 has been described, but the pixel control unit 30 may output the signal TX, the signal RST, and the like of controlling the AF pixel 13. In this case, the pixel control unit 30 also functions as a part of an output unit which outputs a signal of controlling the charge accumulation time of the AF pixel 13.

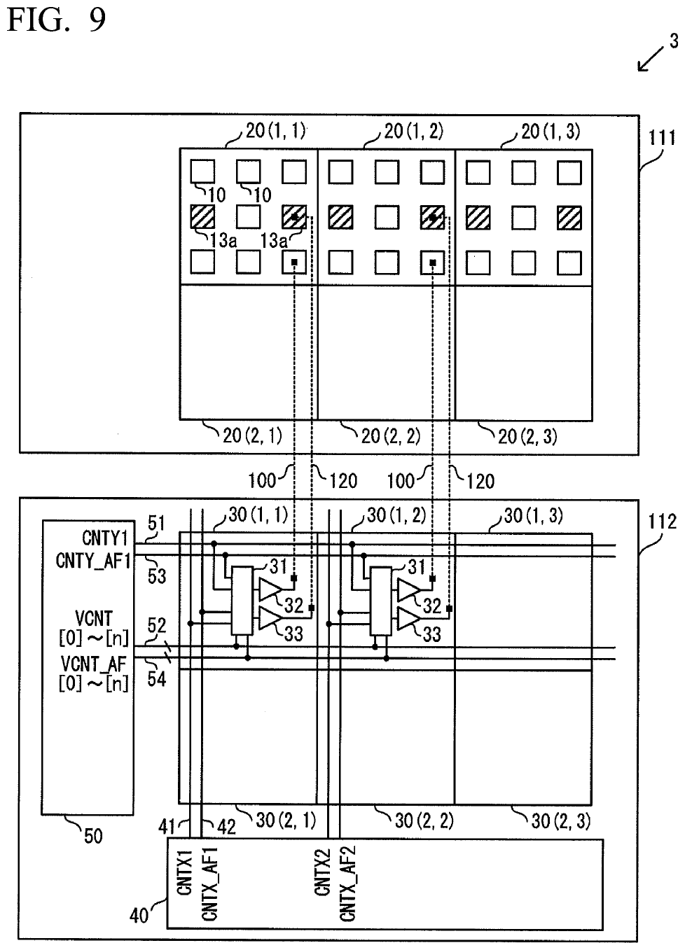

FIG. 9 is a diagram showing a configuration example of a part of an imaging element according to Modified Example 2. In the example shown in FIG. 9, the pixel control unit 30 includes a buffer 33. Further, a signal CNTX_AF is input from the vertical control unit 40 to the selection circuit section 31 via a signal line 42 and a signal CNTY_AF is input from the horizontal control unit 50 thereto via a signal line 53. Further, a plurality of different types of signals VCNT_AF are input from the horizontal control unit 50 to the selection circuit section 31 via a signal line 54.

The selection circuit section 31 selects a signal output to the AF pixel 13 of the pixel block 20 via the buffer 33 from the plurality of types of signals VCNT_AF on the basis of the signal CNTX_AF and the signal CNTY_AF. The buffer 33 supplies the signal TX to each AF pixel 13 of the pixel block 20 via a signal line 120. The signal line 120 is commonly connected to the plurality of AF pixels 13 of the pixel block 20. In the AF pixel 13, the signal TX of controlling the transmission section 12 is input to the gate of the transistor M1 of the transmission section 12 via the signal line 120.

The vertical control unit 40 and the horizontal control unit 50 can individually control the signal TX supplied to the AF pixel 13 of each pixel block 20 by controlling the signal CNTX_AF and the signal CNTY_AF input to the selection circuit section 31 of each pixel control unit 30. Additionally, the pixel control unit 30 is also provided with a selection circuit section, a buffer, and the like which output the signal RST to the AF pixel 13. As in the case of the signal TX, the signal RST is supplied from the pixel control unit 30 to the AF pixel 13. The imaging element 3 according to this modified example can perform control so that the charge accumulation time of the AF pixel 13 is different for each pixel block 20 or the charge accumulation time is the same for all pixel blocks 20.

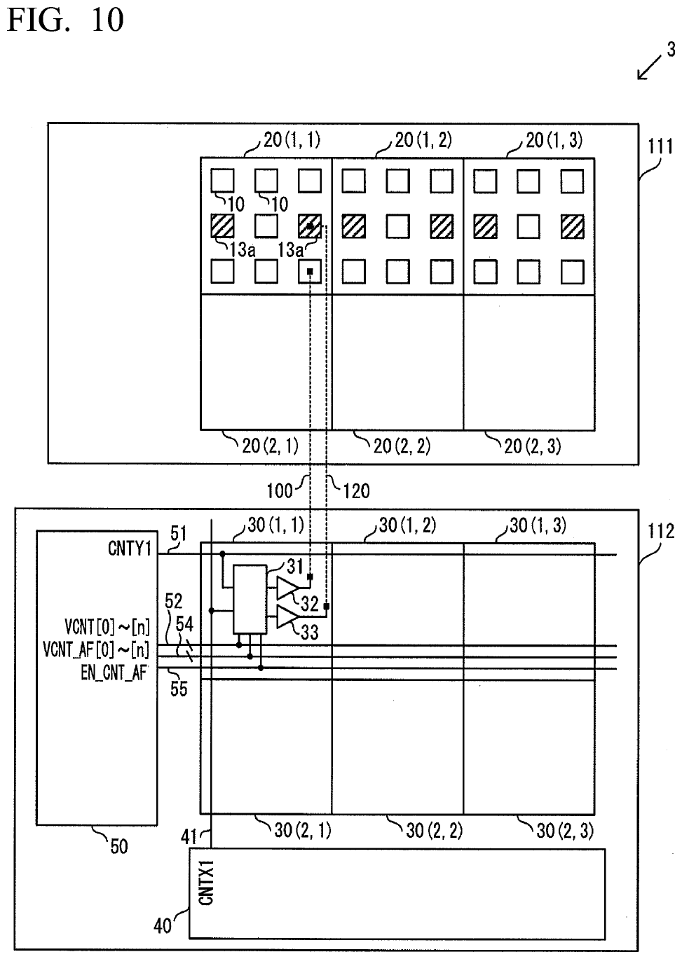

FIG. 10 is a diagram showing another configuration example of a part of the imaging element according to Modified Example 2. A signal EN_CNT_AF is input from the horizontal control unit 50 to the pixel control unit 30 via a signal line 55. The pixel control unit 30 switches the control of the charge accumulation time of the imaging pixel 10 and the control of the charge accumulation time of the AF pixel 13 according to the signal EN_CNT_AF.

When the signal EN_CNT_AF is at a low level, the selection circuit section 31 of the pixel control unit 30 sets the charge accumulation time of the imaging pixel 10 by supplying a signal selected from the plurality of signals VCNT on the basis of the signal CNTX and the signal CNTY to the imaging pixel 10. When the signal EN_CNT_AF is at a high level, the selection circuit section 31 sets the charge accumulation time of the AF pixel 13 by supplying a signal selected from the plurality of signals VCNT_AF on the basis of the signal CNTX and the signal CNTY to the AF pixel 13. In this modified example, since the signal CNTX_AF and the signal CNTY_AF are not necessary, the number of wirings arranged in the imaging element 3 can be reduced and the chip area can be reduced.

### Modified Example 3

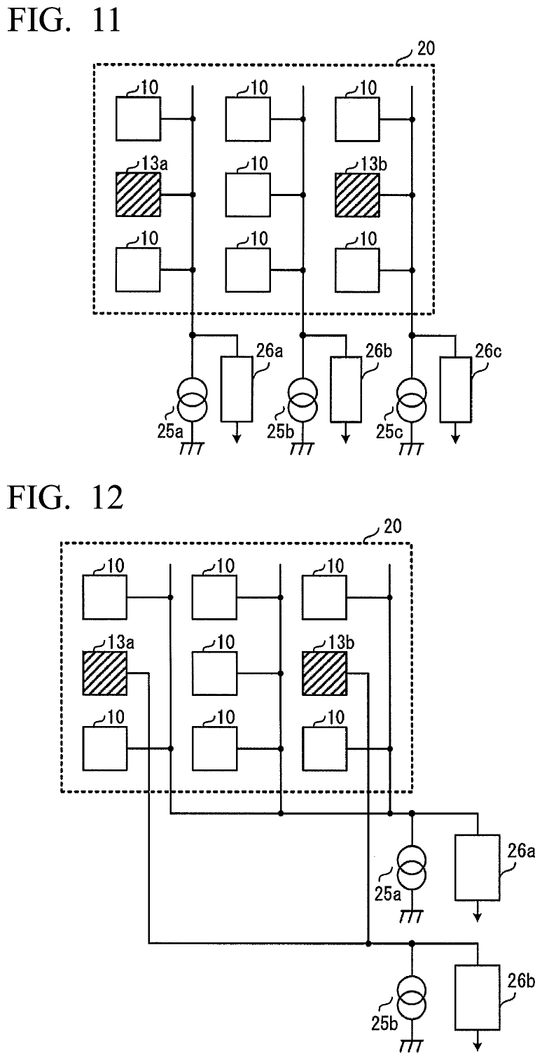

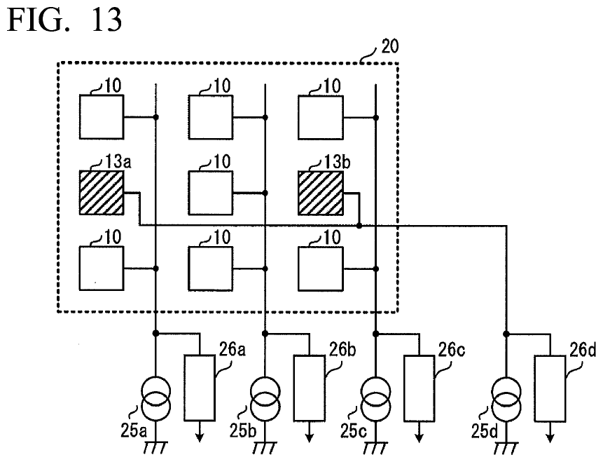

In the above-described embodiment, an example in which the current source 25 and the processing section 26 are provided for each pixel block 20 has been described. However, as shown in FIG. 11, the current source 25 and the processing section 26 may be arranged for each pixel column which is a column of a plurality of pixels arranged in the longitudinal direction, that is, the column direction. Further, as shown in FIG. 12 or 13, the current source 25 and the processing section 26 connected to the imaging pixel 10 and the current source 25 and the processing section 26 connected to the AF pixel 13 may be provided.

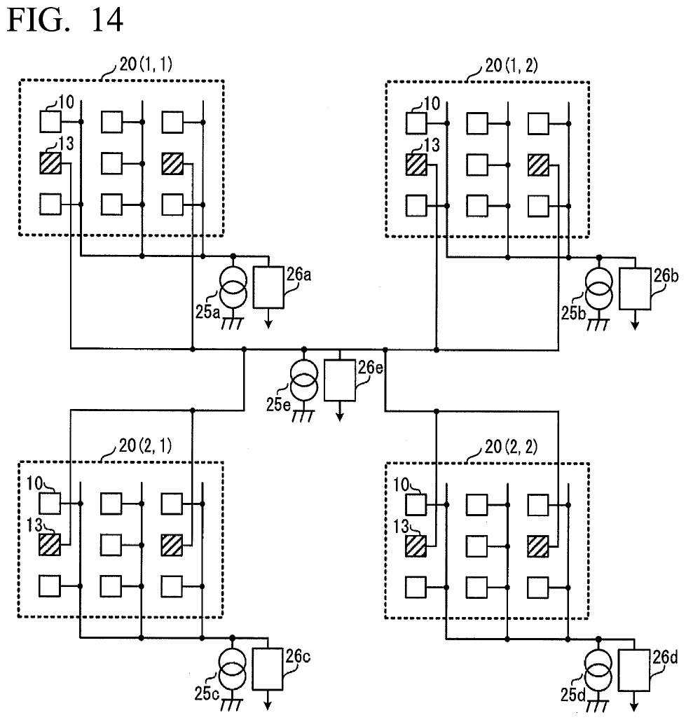

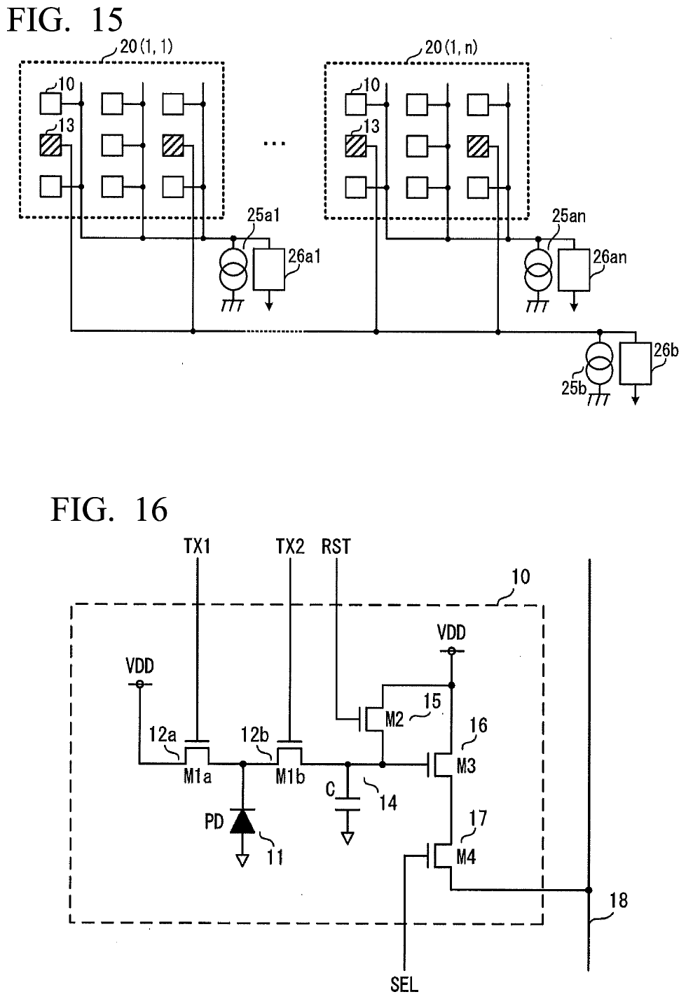

In the example shown in FIG. 12, a processing section 26a is an output unit 26a which outputs a signal from the imaging pixel 10 and a processing section 26b is an output unit 26b which outputs a signal from the AF pixel 13. In the example shown in FIG. 13, the processing sections 26a to 26c are the output units 26a to 26c which output signals from the imaging pixel 10 and a processing section 26d is an output unit 26d which outputs a signal from the AF pixel 13. The reading of the signal of the imaging pixel 10 and the reading of the signal of the AF pixel 13 can be independently performed. Additionally, as shown in FIG. 14 or 15, the current source 25 and the processing section 26 connected to the AF pixel 13 may be provided for each of the plurality of pixel blocks 20 and shared by the AF pixels 13 of the plurality of pixel blocks 20.

### Modified Example 4

In the above-described embodiment, the configuration of the pixel has been described with reference to FIG. 3, but the configuration of each pixel is not limited thereto. FIG. 16 is a diagram showing a configuration example of the pixel of the imaging element according to Modified Example 4. In the example shown in FIG. 16, the pixel includes a first transmission section 12a and a second transmission section 12b.

The first transmission section 12a is composed of a transistor M1a controlled by a signal TX1 and electrically connects or disconnects the photoelectric conversion section 11 and the power supply line (power supply voltage VDD). The first transmission section 12a is the discharge section 12a, discharges charges accumulated in the photoelectric conversion section 11, and resets the voltage of the photoelectric conversion section 11. The transistor M1a is a reset transistor. It can also be said that the transistor M1a of the first transmission section 12a is a transmission transistor which transmits charges photoelectrically converted by the photoelectric conversion section 11 to the power supply line.

The second transmission section 12b is composed of a transistor Mlb controlled by a signal TX2 and electrically connects or disconnects the photoelectric conversion section 11 and the FD 14. The second transmission section 12b transmits charges photoelectrically converted by the photoelectric conversion section 11 to the FD 14. The transistor M1b is a transmission transistor.

The imaging element 3 may set the charge accumulation start time by controlling the charge discharge timing of the photoelectric conversion section 11 using the first transmission section (discharge section) 12a. For example, the pixel control unit 30 controls the charge accumulation time of the imaging pixel 10 by outputting the signal TX1 of controlling the first transmission section 12a of the imaging pixel 10. The horizontal control unit 50 controls the charge accumulation time of the AF pixel 13 by outputting the signal TX1 of controlling the first transmission section 12a of the AF pixel 13. Additionally, the pixel control unit 30 may control the charge accumulation time of each of the imaging pixel 10 and the AF pixel 13.

### Modified Example 5

In the above-described embodiment, an example in which the pixels in the pixel block 20 are sequentially selected and the signal is read from the selected pixel has been described. However, the signal line 18, the current source 25, and the like may be provided for each pixel of the pixel block 20 and the signals may be read from all pixels of the pixel block 20 simultaneously (in parallel).

### Modified Example 6

In the above-described embodiment, an example in which the imaging element 3 is configured by laminating the first substrate 111 and the second substrate 112 has been described. However, the first substrate 111 and the second substrate 112 may not be laminated.

### Modified Example 7

In the above-described embodiment and modified examples, an example in which a photo diode is used as the photoelectric conversion section has been described. However, a photoelectric conversion film (organic photoelectric film) may be used as the photoelectric conversion section.

### Modified Example 8

The imaging element and the imaging device described in the above-described embodiment and modified examples may be applied to a camera, a smartphone, a tablet, a camera built into a PC, a vehicle-mounted camera, a camera mounted on an unmanned aircraft (drone, radio-controlled aircraft, and the like), and the like.

Although various embodiments and modified examples have been described above, the present invention is not limited to these contents. Other embodiments considered within the technical spirit of the present invention are also included in the scope of the present invention.

### REFERENCE SIGNS LIST

1 Imaging device
3 Imaging element
4 Control unit
10 Imaging pixel
11 Photoelectric conversion section
13 AF pixel
14 Accumulation section
15 Discharge section
16 Amplification section
17 Selection section
20 Pixel block
25 Current source
26 Processing section
30 Pixel control unit
31 Selection circuit section
32 Buffer
40 Vertical control unit
50 Horizontal control unit
111 First substrate
112 Second substrate

1. An imaging element comprising:
a plurality of first pixels which are respectively included in a plurality of regions, include first photoelectric conversion sections generating charges by photoelectrically converting light, output signals used to generate an image on the basis of the charges generated by the first photoelectric conversion sections, and are provided in a first direction and a second direction intersecting the first direction;
a second pixel which includes a second photoelectric conversion section generating charges by photoelectrically converting light and outputs signals used to detect a focus on the basis of the charges generated by the second photoelectric conversion section;
a first control line which controls the first pixels; and
a second control line which controls the second pixel.

2. The imaging element according to claim 1,
wherein the first control line outputs a signal of controlling a charge accumulation time of the first photoelectric conversion section, and
wherein the second control line outputs a signal of controlling a charge accumulation time of the second photoelectric conversion section.

3. The imaging element according to claim 1, further comprising:
a first discharge section which discharges charges generated by the first photoelectric conversion section; and
a second discharge section which discharges charges generated by the second photoelectric conversion section,
wherein the first control line outputs a signal of controlling the first discharge section, and
wherein the second control line outputs a signal of controlling the second discharge section.

4. The imaging element according to claim 1, further comprising:
a first accumulation section which accumulates charges generated by the first photoelectric conversion section;
a first transmission section which transmits charges to the first accumulation section;
a second accumulation section which accumulates charges generated by the second photoelectric conversion section; and
a second transmission section which transmits charges to the second accumulation section,
wherein the first control line outputs a signal of controlling the first transmission section, and
wherein the second control line outputs a signal of controlling the second transmission section.

5. The imaging element according to claim 1,
wherein the second control line is provided for each of the plurality of regions.

6. The imaging element according to claim 1,
wherein the second control line outputs a signal of controlling a plurality of the second pixels included in the plurality of regions.

7. The imaging element according to claim 1,
wherein the second control line includes a control line which controls a plurality of the second pixels included in the plurality of regions.

8. The imaging element according to claim 1,
wherein the second control line is provided for each region.

9. The imaging element according to claim 1,
wherein the second control line includes a control line which controls the second pixel included in the region.

10. The imaging element according to claim 1, further comprising:
a first substrate which is provided with the first pixel and the second pixel; and
a second substrate which is provided with the first control line and the second control line and is laminated on the first substrate.

11. The imaging element according to claim 1, further comprising:
a first substrate which is provided with the first pixel, the second pixel, and the second control line; and
a second substrate which is provided with the first control line and is laminated on the first substrate.

12. The imaging element according to claim 1,
wherein a plurality of the second pixels are arranged in the first direction in the region.

13. The imaging element according to claim 1,
wherein the first control line is provided for each region.

14. The imaging element according to claim 1, further comprising:
a processing section which processes a signal output from the first pixel and a signal output from the second pixel.

15. The imaging element according to claim 14,
wherein the processing section is provided for each region.

16. The imaging element according to claim 1, further comprising:
a first processing section which processes a signal output from the first pixel; and
a second processing section which processes a signal output from the second pixel.

17. The imaging element according to claim 16,
wherein the first processing section and the second processing section are provided for each region.

18. The imaging element according to claim 16,
wherein the first processing section is provided for each region, and
wherein the second processing section is provided for each of the plurality of regions.

19. An imaging element comprising:
a plurality of regions which include a plurality of first pixels including a first photoelectric conversion section generating charges by photoelectrically converting light, outputting a signal used to generate an image on the basis of the charges generated by the first photoelectric conversion section, and provided in a first direction and a second direction intersecting the first direction and a plurality of second pixels including second photoelectric conversion sections generating charges by photoelectrically converting light, outputting a signal used to detect a focus on the basis of the charges generated by the second photoelectric conversion sections, and arranged in the first direction;
a first output unit which outputs a signal from the first pixel; and
a second output unit which outputs a signal from the second pixel.

20. An imaging device comprising:
the imaging element according to claim 1; and
a generation unit which generates image data on the basis of a signal output from the imaging element.
